(19) United States
(12) Patent Application Publication
(10) Pub. No.: US 2005/0198182 A1
(43) Pub. Date: Sep. 8, 2005

(54) Method and apparatus to use a genetic algorithm to generate an improved statistical model

(76) Inventors: Vipul Ved Prakash, San Francisco, CA (US); Jordan Ritter, San Francisco, CA (US)

Correspondence Address: John P. Ward;BLAKELY, SOKOLOFF, TAYLOR & ZAFMAN LLP, Seventh Floor, 12400 Wilshire Boulevard, Los Angeles, CA, 90025, US

(21) Appl. No.: 11/071,408

(22) Filed: Mar. 2, 2005

Related U.S. Application Data
(60) Provisional application No. 60/549,683, filed on Mar. 2, 2004.

(51) Int. Cl. G06F 15/16

(52) U.S. Cl. 709/206

(57) ABSTRACT

A method and apparatus to provide an improved statistical model is disclosed. In one embodiment a statistical model for an electronic communication media is generated. The statistical model based on a predetermined set of features of the electronic communication. The statistical model is thereafter processed with a genetic algorithm (GA) to generate a revised statistical mode. In one embodiment, the revised statistical model is provided in a classifier to classify incoming electronic communications. In one embodiment, the classifier is to determine whether a received electronic communication is to be classified as spam or legitimate.

This application claims the benefit of co-pending U.S. Provisional Patent Application No. 60/549,683, which was filed on Mar. 2, 2004; titled “METHOD AND APPARATUS TO USE A GENETIC ALGORITHM TO GENERATE AN IMPROVED STATISTICAL MODEL” (Attorney Docket No. 6747.P003Z) which is incorporated herein by reference.

### FIELD OF THE INVENTION

This invention relates to a method and system to use a genetic algorithm to generate an improved statistical model.

### BACKGROUND

As used herein, the term “spam” refers to electronic communication that is not requested and/or is non-consensual. Also known as “unsolicited commercial e-mail” (UCE), “unsolicited bulk e-mail” (UBE), “gray mail” and just plain “junk mail”, spam is typically used to advertise products. The term “electronic communication” as used herein is to be interpreted broadly to include any type of electronic communication or message including voice mail communications, short message service (SMS) communications, multimedia messaging service (MMS) communications, facsimile communications, etc.

The use of spam to send advertisements to electronic mail users is becoming increasingly popular. Like its paper-based counterpart—junk mail, receiving spam is mostly undesired. Therefore, considerable effort is being brought to bear on the problem of filtering spam before it reaches the in-box of a user.

Currently, rule-based filtering systems that use rules written to filter spam are available. As examples of the rules, consider the following rules:
(a) “if the subject line has the phrase “make money fast” then mark as spam;” and
(b) “if the sender field is blank, then mark as spam.”

Usually thousands of such specialized rules are necessary in order for a rule-based filtering system to be effective in filtering spam. Each of these rules are typically written by a human, which adds to the cost of rule-based filtering systems.

Another problem is that senders of spam (spammers) are adept at changing spam to render the rules ineffective. For example consider the rule (a), above. A spammer will observe that spam with the subject line “make money fast” is being blocked and could, for example, change the subject line of the spam to read “make money quickly.” This change in the subject line renders rule (a) ineffective. Thus, a new rule would need to be written to filter spam with the subject line “make money quickly.” In addition, the old rule (a) will still have to be retained by the system.

With rule-based filtering systems, each incoming electronic communication has to be checked against thousands of active rules. Therefore, rule-based filtering systems require fairly expensive hardware to support the intensive computational load of having to check each incoming electronic communication against the thousands of active rules. Further, intensive nature of rule writing adds to the cost of rule-based systems.

Another approach to fighting spam involves the use of a statistical classifier to classify an incoming electronic communication as spam or as a legitimate electronic communication. This approach does not use rules, but instead the statistical classifier is tuned to predict whether the incoming communication is spam based on an analysis of words that occur frequently in spam. While the use of a statistical classifier represents an improvement over rule-based filtering systems, a system that uses the statistical classifier may be tricked into falsely classifying spam as legitimate communications. For example, spammers may encode the body of an electronic communication in an intermediate incomprehensible form. As a result of this encoding, the statistical classifier is unable to analyze the words within the body of the electronic communication and will erroneously classify the electronic communication as a legitimate electronic communication. Another problem with systems that classify electronic communications as spam based on an analysis of words is that legitimate electronic communications may be erroneously classified as spam if a word commonly found in spam is also used in the legitimate electronic communication.

### SUMMARY OF THE INVENTION

A method and apparatus to provide an improved statistical model is disclosed. In one embodiment, a statistical model for an electronic communication media is generated. The statistical model based on a predetermined set of features of the electronic communication. The statistical model is thereafter processed with a genetic algorithm (GA) to generate a revised statistical model. In one embodiment, the revised statistical model is provided in a classifier to classify incoming electronic communications. In one embodiment, the classifier is to determine whether a received electronic communication is to be classified as spam or legitimate.

### BRIEF DESCRIPTION OF THE DRAWINGS

FIG. 1 presents a flowchart describing the processes of generating an improved statistical model, in accordance with one embodiment of the invention;

FIG. 2 shows a graphical representation of an electronic communication system utilizing an improved statistical model, in accordance with one embodiment of the invention; and

FIG. 3 shows a high-level block diagram of hardware capable of implementing the improved statistical model, in accordance with one embodiment.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

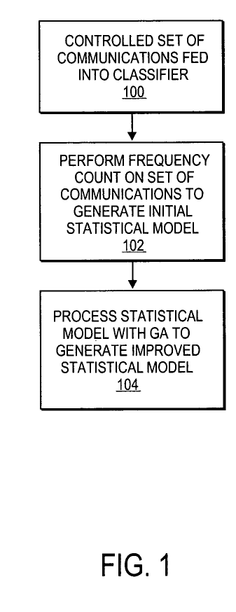

Referring to FIG. 1 of the drawings, a flowchart is presented describing the processes of improving and/or optimizing a statistical model, in accordance with one embodiment. Starting at block 100, a controlled set of communications are fed into a first classifier to perform a frequency count training to generate an initial statistical model. In one embodiment, the controlled set includes a known quantity of spam and a known quantity of legitimate communications.

In block 102, a frequency count is performed on the set of communications to identify the frequency a predetermined set of features present in the spam communications and present in the legitimate communications. In one embodiment, the predetermined features relate to changes or mutations to the structure of an electronic communication (e.g., a header of an electronic communication, and/or a body of an electronic communication). In one embodiment, the features relate to the structure of an electronic communication as opposed to individual words in the content the electronic communication. In one embodiment, the generated set of frequencies (i.e., values) for each of the features, as they are identified in the spam and legitimate communications, represents the initial statistical model.

In block 104, an algorithm is used to improve and/or optimize the statistical model used to classify an electronic communication into one of a plurality of groups or categories. In one embodiment, a genetic algorithm is used.

In one embodiment, the initial statistical model of features generated in process block 102 is fed into an algorithm, along with a second corpus of known spam and legitimate electronic communications. The algorithm alters the values of the predefined features (also referred to as “genes,” “mutations,” or “anomalies”) relating to the structures of electronic communications, to evolve an improved statistical model (also referred to as “a spam DNA”), which could be considered a blueprint for spam or a legitimate communication, respectively.

Details of one example of algorithm that may be used to practice embodiments of the invention are provided as follows. In what follows, p_spam and p_legit are frequency counts for particular features found in spam and legitimate electronic communications, respectively. Suppose a feature A1 is found in 200 spam messages in a corpus of 500 spam messages, then A1's p_spam percentage is 40.00%.

In one embodiment, the algorithm is used to iteratively evolve p_spam and p_legit values for features based on a set of fitness function that consists of overall accuracy and false positive numbers.

Firstly, without using the fitness function, features found are classified into two classes, viz. spam and legit. In one embodiment, if p_spam>p_legit, the feature will be classified as a spam feature, otherwise as a legit feature. Each electronic communication in a spool of n spam messages and n legit messages is then checked for the presence of all features. During the process of checking features, in one embodiment, a set of frequency tables (hashes/maps/) are created: One example of an embodiment of the tables is shown below (the tables may be varied within the scope of the invention):

Frequency Table A: Spam features found in legit messages which are classified as spam will be stored in Frequency Table A.

Frequency Table B: Legit features found in spam messages, which are classified as legit, will be stored in Frequency Table B.

Frequency Table C: Spam features found in spam messages, which are classified, as legit will be stored in Frequency Table C.

Frequency Table D: Legit features found in legit messages, which are classified as spam messages will be stored in Frequency Table D.

Set forth below is an example of different features (e.g., A1, A2, A3 . . . ) in the Frequency Table A and the Frequency Table B:

| Frequency Table A: | Frequency Table B: |
|---|---|
| A1 −> 35 | A9 −> 80 |
| A2 −> 27 | A10 −> 38 |
| A3 −> 20 | A11 −> 23 |

Secondly, in one embodiment, for each entry in the example Tables A-D, a fitness function, from the set of fitness functions, is used to:
1) Reduce y % from p_spam of every feature in FT A;
2) Reduce y % from p_legit of every feature in FT B;
3) Add y % to p_spam of every feature in FT C; and
4) Add y % to p_legit of every feature in FT D, where
   y=freq(feature)/freqsum(all_features)*pa*rand(1,pm);
pa=acceleration
pm=mutation rate.
   pa is an acceleration value to speed up evolution, and mutation is the mutation rate that should be greater than or equal to 1. Both acceleration and mutation default to 1, in one embodiment. The process of checking is repeated one or more times using the new values for p_spam and p_legit, in one embodiment. Eventually weights for the features are evolved to a point where the frequencies of entries in Tables A and B are at a minimum while the frequencies for entries in Tables C and D are at a maximum. Alternative techniques, algorithms, and variations may be used within the scope of the invention.

The technique of using iteratively modifying weights of features may be used generally in a variety of statistical classification technique, in which the frequencies of selected features for an input determine the categorization of the input. Thus, the techniques disclosed herein are not limited to classification of electronic communications, but are generally applicable to the classification of other inputs based on a statistical model.

The revised statistical model, as generated in process block 104 may thereafter be loaded into a classification algorithm of a classifier, and used to provide a confidence level of whether in coming communications are spam. In one embodiment, the classifier can be loaded into an electronic communication transfer agent, such as a mail server.

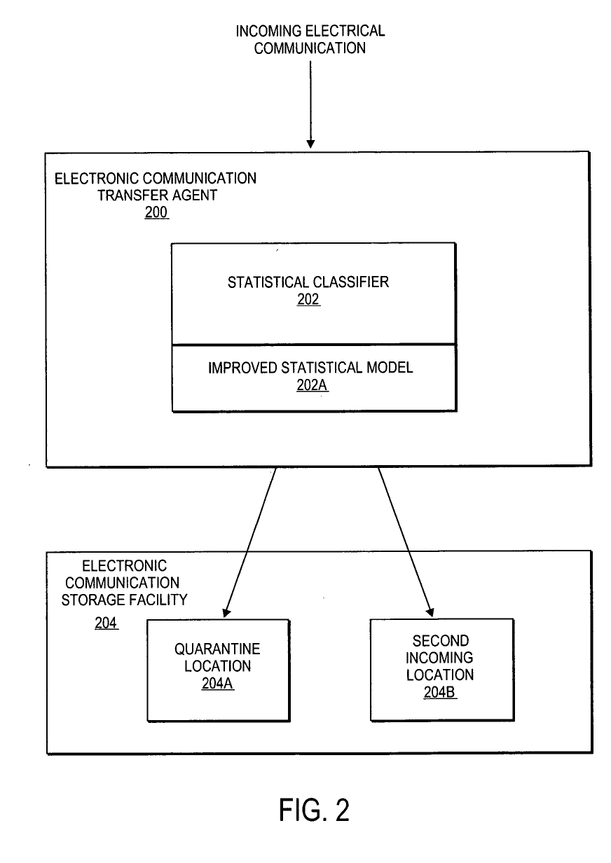

Referring to FIG. 2 of the drawings, in one embodiment, a statistical classifier 202 is loaded into a component responsible for the delivery of electronic communications, e.g., an electronic communication transfer agent 200. As will be seen, the statistical classifier 202 includes the improved statistical model 202A, which is generated using the algorithm as described above. Incoming electronic communications received by the electronic communication transfer agent are classified by the statistical classifier 202, using the improved statistical model 202A. In one embodiment, an electronic communication storage facility 204 is coupled to the electronic communication transfer agent 200 and may include a quarantine location 204a for communications classified as a first type (e.g., spam), and a second incoming location 204b for communications classified as a second type (e.g., legitimate). The electronic communication storage facility 204 may be accessed by an electronic communication client in order to retrieve electronic communications.

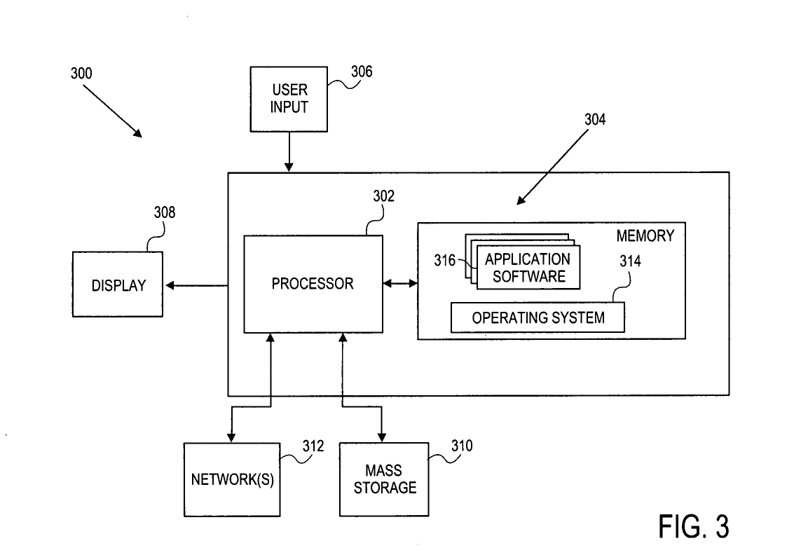

Referring to FIG. 3 of the drawings, reference numeral 300 generally indicates hardware that may be used to implement an electronic communication transfer agent server in accordance with one embodiment. The hardware 300 typically includes at least one processor 302 coupled to a memory 304. The processor 302 may represent one or more processors (e.g., microprocessors), and the memory 304 may represent random access memory (RAM) devices comprising a main storage of the hardware 300, as well as any supplemental levels of memory e.g., cache memories, non-volatile or back-up memories (e.g. programmable or flash memories), read-only memories, etc. In addition, the memory 304 may be considered to include memory storage physically located elsewhere in the hardware 300, e.g. any cache memory in the processor 302, as well as any storage capacity used as a virtual memory, e.g., as stored on a mass storage device 310.

The hardware 300 also typically receives a number of inputs and outputs for communicating information externally. For interface with a user or operator, the hardware 300 may include one or more user input devices 306 (e.g., a keyboard, a mouse, etc.) and a display 308 (e.g., a Cathode Ray Tube (CRT) monitor, a Liquid Crystal Display (LCD) panel).

For additional storage, the hardware 300 may also include one or more mass storage devices 310, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 300 may include an interface with one or more networks 312 (e.g., a local area network (LAN), a wide area network (WAN), a Wireless network, and/or the Internet among others) to permit the communication of information with other computers coupled to the networks.

The processes described above can be stored in the memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

Although the present invention has been described with reference to specific exemplary embodiments, it will be evident that the various modifications and changes can be made to these embodiments without departing from the broader spirit of the invention as set forth in the claims. Accordingly, the specification and drawings are to be regarded in an illustrative sense rather than in a restrictive sense.

1). A method comprising:
generating a statistical model for electronic communication media, the statistical model based on a predetermined set of features of the electronic communication; and
processing the statistical model with a genetic algorithm (GA) to generate a revised statistical model.

2). The method of claim 1 further including providing the revised statistical model in a classifier to classify incoming electronic communications within one or more predefined categories.

3). The method of claim 2, wherein the set of features include features relating to a structure of the electronic communication.

4). The method of claim 3, wherein the electronic communication is an electronic document.

5). The method of claim 3, wherein the electronic communication is an email.

6). The method of claim 3, wherein generating the statistical model includes basing the statistical model upon a first set of electronic communication, and basing the revised statistical model upon a second separate set of electronic communications.

7). The method of claim 1, wherein processing the statistical model with the GA results in a revised statistical model that more classifies electronic communications into the one or more predefined categories represented by the statistical model.

8). The method of claim 7, wherein processing the statistical model includes deriving additional features of the electronic communication for the revised statistical model.

9). A machine-readable medium having stored thereon a set of instructions which when executed cause a system to perform a method comprising of:
generating a statistical model for electronic communication media, the statistical model based on a predetermined set of features of the electronic communication; and
processing the statistical model with a genetic algorithm (GA) to generate a revised statistical model.

10). The machine-readable medium of claim 9, wherein the method further includes providing the revised statistical model in a classifier to classify incoming electronic communications with one or more predefined categories.

11). The machine-readable medium of claim 9, wherein the set of features include features relating to a structure of the electronic communication.

12). The machine-readable medium of claim 11, wherein the electronic communication is an electronic document.

13). The machine-readable medium of claim 11, wherein generating the statistical model includes basing the statistical model upon a first set of electronic communication, and basing the revised statistical model upon a second separate set of electronic communications.

14). The machine-readable medium of claim 9, wherein processing the statistical model with the GA results in a revised statistical model that more classifies electronic communications into the one or more predefined categories represented by the statistical model.

15). The machine-readable medium of claim 17, wherein processing the statistical model includes deriving additional features of the electronic communication for the revised statistical model.

16). A system comprising:
a processor;
a network interface coupled to the processor;
a means for generating a statistical model for electronic communication media, the statistical model based on a predetermined set of features of the electronic communication; and
a means for processing the statistical model with a genetic algorithm (GA) to generate a revised statistical model.

17). The system of claim 16, further comprising wherein means for providing the revisedstatistical model in a classifier to classify incoming electronic communications within one or more predefined categories.

18). The system of claim 17, wherein the set of features include features relating to a structure of the electronic communication.

19). The system of claim 18, wherein the means for generating the statistical model includes means for basing the statistical model upon a first set of electronic communication, and basing the revised statistical model upon a second separate set of electronic communications.

20). The system of claim 16, wherein the means for processing the statistical model with the GA generates a revised statistical model that classifies electronic communications into the one or more predefined categories represented by the statistical model.
